(19) United States
(12) Patent Application Publication
(10) Pub. No.: US 2007/0260976 A1
(43) Pub. Date: Nov. 8, 2007

(54) Rule Engines and Methods of Using Same

(76) Inventors: Judith A. Slein, Rochester, NY (US); Paul R. Austin, Webster, NY (US); Mary Charlotte Baltus, Rochester, NY (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/381,193

(22) Filed: May 2, 2006

(51) Int. Cl. G06F 15/00

(52) U.S. Cl. 715/523

(57) ABSTRACT

A rule engine includes a rule set containing one or more rules, a rule evaluator that applies a rule from the rule set to one or more facts from an unstructured document and evaluates whether the condition for the applied rule is satisfied based on the one or more facts. An action executor performs one or more actions for the rule if the rule evaluator determines that the condition for the applied rule is satisfied.

### CROSS-REFERENCE TO RELATED APPLICATIONS

Not Applicable.

### STATEMENT REGARDING FEDERAL SPONSORED RESEARCH

Not Applicable.

### JOINT RESEARCH AGREEMENT

Not Applicable.

### INCORPORATION BY REFERENCE OF MATERIAL ON DISC

Not Applicable.

### BACKGROUND

1. Technical Field

The disclosed embodiments relate to computer-implemented rule engines. The disclosed embodiments specifically relate to methods and systems for evaluating rules and performing actions or providing responses based on the outcome of the rule evaluations.

2. Background

A rule engine is typically used to evaluate rules as applied to data. Based on the outcome of the rule evaluations, one or more actions are performed and/or one or more responses are provided.

Conventional rule engines typically use proprietary rule syntaxes and data formats that differ among rule engines. When a developer encounters a previously unused rule syntax and/or data formats the developer must receive instruction in the syntax and/or format prior to working with the rule engine. Because the number of developers having experience with each particular rule engine is typically small, such instruction is commonplace, resulting in a loss of developer productivity.

In the past three decades tremendous progress has been made in developing databases and programs that use them. we often refer to the data contained therein as “structured data,” which conforms to predefined relationships and structures. It is not the case, however, that all knowledge is readily represented as structured data. Estimates are that as much as 80% of knowledge is represented in unstructured forms, most notably documents such as papers, articles, letters, and email. Since much of this has been communicated personally, there is little consistent organization which can be used to find and exploit the valuable information. What is needed is a method and system that brings the power of rule based systems to bear on the problem of unstructured data.

A further need exists for a rule engine and a method of using such an engine that includes a standardized rule syntax and data format to facilitate the ability of developers to utilize and develop new rule engines in an efficient manner.

A further need exists for a rule engine and a method of using such an engine that are not dependent upon proprietary syntaxes and/or data formats.

The disclosed embodiments are directed to solving one or more of the above-listed problems.

### SUMMARY

Before the present methods and systems are described, it is to be understood that this invention is not limited to the particular, systems, methodologies or protocols described, as these may vary. It is also to be understood that the terminology used herein is for the purpose of describing particular embodiments only, and is not intended to limit the scope of the present disclosure which will be limited only by the appended claims.

It must be noted that as used herein and in the appended claims, the singular forms “a,” “an,” and “the” include plural reference unless the context clearly dictates otherwise. Thus, for example, reference to a “document” is a reference to one or more documents and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of the present invention, the preferred methods, devices, and materials are now described. All publications mentioned herein are incorporated herein by reference. Nothing herein is to be construed as an admission that the invention is not entitled to antedate such disclosure by virtue of prior invention.

In an embodiment, a method of processing unstructured data includes accessing a rule set containing one or more rules stored in a computer-readable memory. Each rule includes a condition and one or more actions, and the actions may include one or more parameters. The method may include receiving one or more facts from an unstructured document. For at least one rule in the rule set, the method also may include evaluating whether the condition for the rule is satisfied based on the one or more facts, and if satisfied, performing each action for the rule based on the one or more parameters for the action.

In some embodiments the condition for a rule may include an expression such as an XPath expression, and the expression may prompt or involve a review of the unstructured document for the presence of at least one fact and return a value based on the evaluation of the at least one fact. The rules may include templates, such as XSLT templates, and/r they may be represented in a language such as XML. The method may include prioritizing a plurality of rules in the rule set, wherein the rule used in the determining is based on the prioritization. Optionally, the determining and performing an action may be performed for a plurality of rules in the rule set in an order determined by at least the prioritization.

In an alternate embodiment, a rule engine includes a rule set containing one or more rules, wherein each rule comprises a condition. It also may include a rule evaluator that applies a rule from the rule set to one or more facts from an unstructured document and evaluates whether the condition for the applied rule is satisfied based on the one or more facts. It also may include an action executor that performs one or more actions for the rule if the rule evaluator determines that the condition for the applied rule is satisfied.

In some embodiments, the action executor determines the action from the applied rule. The condition for a rule may include an expression such as an XPath expression, wherein the expression prompts evaluation based on at least one fact and returns a value based on the evaluation of the at least one fact. In some embodiments, the rules in the rule set may be represented in XML. In some embodiments, the rules in the rule set may be represented as an XSLT template.

In some embodiments, the rule engine also may include a preprocessor, wherein the preprocessor accepts one or more preprocessing instructions, wherein the preprocessing instructions describe one or more operations for receiving global parameters. In some embodiments, the rule engine also may include an action library for storing one or more actions, wherein the action executor calls or determines instructions for implementing the action from the action library. In some embodiments, each rule may include a priority, and the rule evaluator may evaluate the rules in an order determined by at least the priority for each rule.

### BRIEF DESCRIPTION OF THE DRAWINGS

Aspects, features, benefits and advantages of the present invention will be apparent with regard to the following description and accompanying drawings, of which:

FIG. 1 depicts an exemplary rule engine according to an embodiment.

FIG. 2 depicts an alternate exemplary rule engine according to an embodiment.

FIG. 3 is a block diagram of exemplary internal hardware that may be used to contain or implement program instructions according to an embodiment.

### DETAILED DESCRIPTION

The Extensible Markup Language (XML) is a general-purpose markup language for creating special-purpose markup languages, which are capable of describing many different kinds of data. XML documents use text to describe and apply a tree-based structure to information. All information is represented by text, interspersed with markup or “tags” indicating the information's separation into a hierarchy of character data, container-like elements and attributes of those elements. XML facilitates the sharing of data across different systems, such as systems connected via a computer network, such as the Internet and/or an intranet.

The fundamental unit in XML is the character. Characters are combined in certain allowable combinations to form, for example, an XML document, which includes one or more elements. Each element serves to hold some portion of the document's characters and may be encoded as a series of bits. An element typically includes a start tag (typically a name surrounded by angle brackets) and an end tag (typically the same name preceded by a forward slash and surrounded by angle brackets). Elements may have one or more attributes (i.e., name-value pairs), and any element may have sub-elements. Each XML document also includes a root element that serves as a top-level or identifier element.

XML provides a syntactic foundation for the creation or custom documents by leaving the names, allowable hierarchy, and meanings of the elements and attributes open and definable by a customizable schema. The general syntax of such languages is rigid in that documents must adhere to the general rules of XML to assure that all XML-aware software can parse and understand the relative arrangement of information within them. However, a schema provides a set of constraints within which all elements must abide. For example, schemas may permit only elements with certain names (e.g., “<loan amount>”/or attributes (e.g., the element named “<loan amount>” must contain one element named “dollars” and one element named “interest rate”).

Not all XML documents require a schema. Some documents may include XML elements without being subject to any particular schema. Such documents are considered to be “unstructured” in the context of XML.

XPath is a language used to address parts of an XML documents XPath provides basic facilities for manipulation of strings, numbers and Booleans to address such documents. An XPath expression is an expression or command that searches through an XML document and extracts information from the nodes (i.e., definable portions of the document, such as elements or attributes) of the document. XPath may use, for example, a compact, non-XML syntax that facilitates the use of XPath expressions within, for example, Uniform Resource identifiers (URIs) and XML attribute values. XPath may operate on the abstract, logical features of an XML document, rather than ins surface syntax or schema. In addition, XPath may be used for matching (i.e., testing whether or not a node matches a particular pattern). XPath includes provisions for logical combinations of information (e.g., the use of connectors such as and, or, not) similar to the antecedent (conditional) parts of rules.

The Extensible Stylesheet Language (XSL) is a stylesheet language for XML. XSL includes XSL Transformations (XSLT) and an XML vocabulary for specifying formatting semantics. An XSL stylesheet specifies the presentation of a class of XML documents by describing how an instance of the class is transformed into an XML document that uses the formatting vocabulary. A stylesheet is a group of declarations (written in plain text) that allows a user to change the presentation of particular features of an XML file, without having to change the structure.

XSLT enables the transformation of XML documents into other XML or non-XML documents. XSLT is designed for use as part of XSL. In particular, XSL specifies the styling of an XML document by using XSLT to describe how the document is transformed into another document that uses the formatting vocabulary. For example, XSLT may be used to transform an XML file into an HTML page.

XML facilitates the use of information both by people and by computers. It also permits unstructured documents and irregularly structured documents to be manipulated by one or it more computers or computer systems. Developers that can program in XML and related standards, such as XSLT, are becoming commonplace as a result. In addition, XML and XSLT processors are freely available.

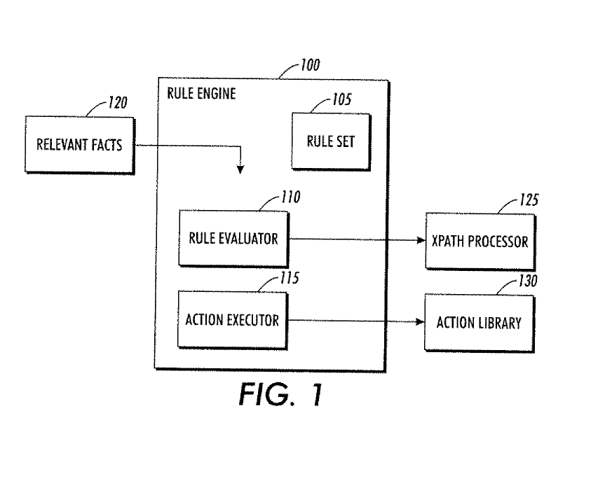

FIG. 1 depicts an exemplary rule engine according to an embodiment. As shown in FIG. 1, a rule engine 100 may include or have access to one or more rules 105, a rule evaluator 110 and an action executor 115. The rule engine may be a computing device that implements instructions to accomplish the features described herein, or it may be the instructions that allow the features to be implemented or a computing device. A rule may be a computer-readable instruction that includes one or more conditions and one or more actions that are performed if the conditions are satisfied. The rules 105 may be represented in an XML vocabulary that is understood by the rule engine 100. The rules 105 may be evaluated based on one or more facts 120. The facts may be contained in, and evaluated from, one or more unstructured documents such as letters, articles, white papers, electronic mail messages, memos or documents that do not require a predefined relationship or structure. The unstructured documents may be stored in electronic form such as a data file. Each fact 120 may be represented in any XML language, and not just the XML language used to represent the rules 105. Hence, facts may be contained in, and evaluated from, unstructured documents. Each rule 105 may include a condition that is represented by, for example, an XPath expression. For example, a rule may include a command to search an XML document's nodes for the existence of certain text (an example of a fact), and to take an action such as including the document in a list of relevant document if the text exists more than a specified number of times.

The one or more facts 120 may vary based on the application to which the rule engine 100 is applied. For example, if the rule engine 100 is used in relation to a mortgage application, the one or more facts 120 may include, without limitation, a list of one or more properties that have been modified, a name assigned to a mortgage application, an applicant's name, an underwriter's name, a closing date, and a type of mortgage. In typical lender's offices these facts may be represented in a collection of documents such as the loan application, corroborating financial documents like income tax returns, and other documents. Additional or alternate facts 120 may also be included within the scope of this disclosure.

The rule evaluator 110 may evaluate the one or more rules 105 against the one or more facts 120. The rule evaluator 110 may Include an XPath processor 1251 either alone or in connection with other rule evaluators to evaluate the rules 105 against the facts 120. In an embodiment, the rule evaluator 110 may evaluate the rules 105 in the order that the rules appear in a set of rules, or via one or more other indicators of priority.

If a condition of a rule 105 is satisfied based on the facts 120, the action executor 115 may be used to perform one or more actions and/or provide one or more responses specified by the rule. The action executor 115 may access an action library 130 to call or determine specific instructions that are to be implemented in response to the one or more actions specified in each satisfied rule 105. The action library may include a computer-readable medium containing instructions that may be called in order to perform an action. Each action may include one or more parameters that are specified by the rule 105. Parameters may be represented, for example, as an XPath expression that is evaluated against the XML representation of the one or more facts 120.

An XML rule 105 may include a condition and one or more actions and/or responses. An exemplary XML rule is listed in Table 1. The exemplary rule includes a condition (“test”) that is evaluated. The condition in the exemplary rule is represented as an XPath expression.

An XPath expression may be evaluated with respect to a context. The context may be determined based on one or more variables defined in the XPath expression. The result of evaluating an XPath expression may be an object, such as a Boolean value, a number and/or a string. For example, an XPath expression used in the exemplary rule in Table 1 is “contains (@propertiesChanged, ‘ClosingDate’).” The XPath expression may examine the value of a propertiesChanged variable in one or more facts, such as is shown in Table 2, to determine whether the term ‘ClosingDate’ is included. If it is included, the XPath expression may return a TRUE value. Otherwise, a FALSE value may be returned.

A second XPath expression used in the exemplary rule in Table 1 is “concat(‘Rule002:’, @handle, ‘Closing Date Set.’).” In this case, a string may be formed by concatenating the literal string “Rule002:”, the value of the variable ‘handle’ and the literal string “Closing Date Set.”

A third XPath expression used in the exemplary rule in Table 1 is “@ClosingDate,” which returns the value of the variable ‘Closingdate.’ Other Xpath expressions may also be used within the scope of the present disclosure.

The exemplary rule shown in Table 1 performs two actions (“LogAction” and “SetAlarmRelativeAction”) if the condition is satisfied. Each action includes defined parameters used to perform the action if the condition is satisfied.

TABLE 1
Exemplary Rule

<rule id=“Rule002”>

<condition>

<test>(contains(@propertiesChanged, ‘ClosingDate’))</test>
<context>/</context>

</condition>
<action name=“com.rulesengine.actions.LogAction”>

<param name=“level”>info</param>
<param name=“message”>concat(‘Rule002: ’, @handle, ‘

Closing Date Set.’)</param>

</action>
<action name=“com.rulesengine.actions.SetAlarmRelativeAction”>

<param name=“id”>MortgageCaseDocumentsDue</param>
<param name=“base-date”>@ClosingDate</param>
<param name=“direction”>−</param>
<param name=“offset”>SIXTY_DAYS</param>
<param name=“context”>.</param>

</action>

</rule>

The condition for the exemplary rule 105 may be represented as an XPath expression and may include the context for which it should be evaluated. The rule evaluator 110 may invoke the XPath processor 125 to apply the condition to the XML representation of the one or more facts 120. If the relevant facts 120 include those shown in Table 2, the condition for the rule 105 may evaluate to ‘true,’ and the actions for the rule may be invoked.

TABLE 2
Exemplary XML Representation of Facts

<MortgageCase propertiesChanged=“UnderwriterName, ClosingDate,
MortgageType” handle=“MortgageCase-03”
UnderwriterName=“Smith01”
ClosingDate=“20050930” MortgageType=“ResFixed30”
ApplicantName=“Jones, Paul”>

<Application handle=“Application-03” />

</MortgageCase>

In an embodiment, the actions may be specified such that the action executor 115 is able to invoke an actor from the action library 130 to perform the specified action. Actors may include existing or dynamically-loaded in-memory entities such as a method or class, or out-of-process actors such as script interpreters or command line applications. The action executor 115 may provide the invoked execution entity with one or more parameters required for the action. Each actor may implement an action interface to facilitate invocation by the action executor 115. The parameter values may include XPath expressions and/or literal values.

In an embodiment, the rule engine 100 may be used to implement any rule-based evaluation. For example, an exemplary rule engine 100 may be used to enhance a workflow service. An alternate exemplary rule engine 100 may be used to perform document process management operations, such as for mortgage applications, insurance claims, new account applications and the like.

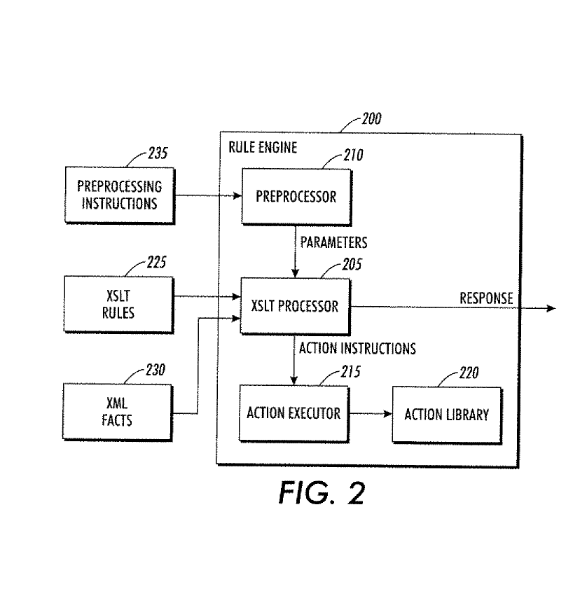

FIG. 2 depicts an alternate exemplary rule engine according to an embodiment. As shown in FIG. 2, a rule engine 200 may include an XSLT processor 205, a preprocessor 210, an action executor 215 and an action library 220. The XSLT processor 205 may receive one or more rules 225 and one or more facts 230. A rule may be a computer-readable instruction that includes one or more conditions and one or more actions that are performed if the conditions are satisfied. In an embodiment, each rule 225 may be represented as an XSLT template. A XSLT template may include a match attribute and content. In an embodiment, a condition for each rule 225 may be described by the match attribute for a template, and one or more actions and/or responses may be described in the content for the template. Each rule 225 may then be evaluated by the XSLT processor 205.

In an embodiment, a rule 225 may perform one or more actions and/or provide one or more responses if its condition is satisfied. For example, if a rule 225 seeks a response to a query about particular data, the content generated for the template associated with the rule may include, for example, a report formatted for display that responds to the query. Alternately or additionally, if a rule 225 specifies one or more actions to be performed, the content generated for the rule may Identify one or more functions to be executed and one or more arguments for each function. In either case, a supporting framework (not shown) may be used to, for example, display the report and/or invoke the function. For example, a printer and/or a monitor may be used to display a report.

The one or more rules 225 may be organized as a rule set. In an embodiment, the rule set 225 may require access to one or more facts that are not contained in the XML facts 230. Such additional facts may be used, for example, to evaluate conditions and/or construct a response. If such additional facts are used, the facts may be represented in the rule set as, for example, global XSLT parameters having values supplied by the rule engine 200 when the XSLT processor 205 is invoked. In an embodiment, the rule engine 200 may accept preprocessing instructions 235 using a preprocessor 210 that describe how the rule engine may receive any required parameter values.

In an embodiment, the action library 220 and an action executor 215 may be used. The action library 220 may include one or more actions. The action executor 215 may include software and/or hardware used to execute an action from the action library 220. Each action may be implemented as a Java class. The Java class may be used to implement an action interface that facilitates the ability for software to instantiate and invoke an action.

In some embodiments, an XSLT processor 205 may incorporate a conflict resolution strategy. The rule set 225 may guide the application of the conflict resolution strategy by assigning a priority to each rule that may be invoked when a conflict occurs. As one way of resolving conflicts, in an embodiment, an XSLT processor 205 may only execute actions and/or generate responses for a single rule 225. Alternatively rules may be prioritized, and in an embodiment, each rule's priority may be based on the order of the rule within rule set. In an embodiment, the rules in the rule set may be evaluated in an order based on the priority for each rule.

However, rule conflict resolution is an option, and in some cases it may be desirable to not resolve rule conflicts but instead allow all applicable rules to run. For example, in the case of a mortgage application, if a closing date changes and one rule says “if the closing date changes then notify all parties” and another says “if the closing date changes, and is less than two weeks from now, and required information is missing, then notify the underwriter of the missing information” it may be desirable to allow both rules to run, not just one with higher priority.

In an alternate embodiment, an application may desire that actions for a plurality of satisfied rules 225 be executed and that the reports for all such rules be performed. For such applications, particular coding techniques may be used to perform all required actions.

For example, if the facts 230 satisfy each of the three templates in Table 3, only one of the templates may be executed.

TABLE 3
XSL Template that Executes One Rule

<xsl:template match=“A[@x=‘true’]”>

Do X

</template>
<xsl:template match=“A[@y=‘true’]”>

Do Y

</template>
<xsl:template match=“A[@z=‘true’]”>

Do Z

</xsl:template>

If a particular application requires the actions and/or responses for each rule 225 to be executed, the rules may be organized as in Table 4.

TABLE 4
XSL Template that Can Execute Multiple Rules

<xsl:template match=“A”>

<xsl:if test=“@x=‘true’”>

Do X

</xsl:if>
<xsl:if test=“@y=‘true’”>

Do Y

</xsl:if>
<xsl:if test=“@z=‘true’”>

Do Z

</xsl:if>

</xsl:template>

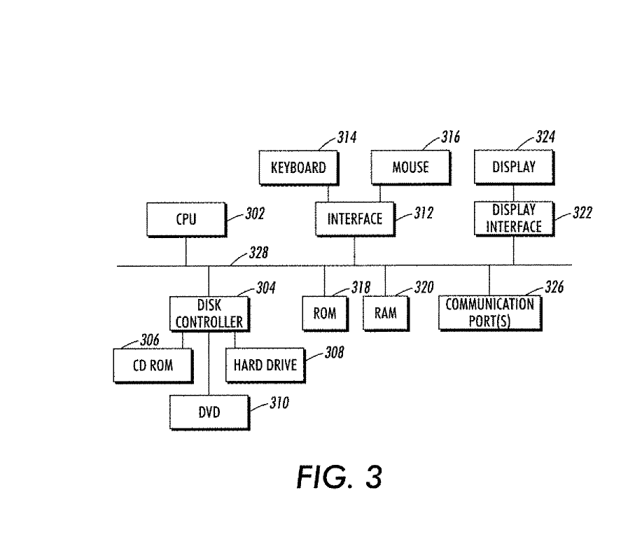

FIG. 3 is a block diagram of exemplary internal hardware that may be used to contain or implement program instructions according to an embodiment. Referring to FIG. 5, a bus 328 may serve as a main information highway interconnecting the other illustrated components of the hardware. CPU 302 is the central processing unit of the system, performing calculations and logic operations required to execute a program. Read only memory (ROM) 318 and random access memory (RAM) 320 constitute exemplary memory devices.

A disk controller 304 interfaces with one or more optional disk drives to the system bus 328. These disk drives may be, for example, external or internal CD ROM drives 306, hard drives 308 or DVD drives 310. As indicated previously, these various disk drives and disk controllers are optional devices.

Program instructions may be stored in the ROM 318 and/or the RAM 320F Optionally, program instructions may be stored on a computer readable medium such as a USE key or a digital disk or other recording medium, a communications signal or a carrier wave.

An optional display interface 322 may permit information from the bus 328 to be displayed on the display 324 in audio, graphic or alphanumeric format. Communication with external devices may optionally occur using various communication ports 326. An exemplary communication port 326 may be attached to a communications network, such as the Internet or an intranet.

In addition to computer-type components and their equivalents, the hardware may also include an interface 312 which allows for receipt of data from input devices such as a keyboard 314 or other input device 316 such as a remote control, pointer and/or joystick.

A multiprocessor system may optionally be used to perform one, some or all of the operations described herein. Likewise, an embedded system may optionally be used to perform one, some or all of the operations described herein.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the disclosed embodiments.

What is claimed is:

1. A method of processing unstructured data, comprising:
accessing a rule set containing one or more rules stored in a computer-readable memory, wherein each rule comprises a condition and one or more actions, wherein the actions each include one or more parameters;
receiving one or more facts from an unstructured document; and
for at least one rule in the rule set:
evaluating whether the condition for the rule is satisfied based on the one or more facts, and
if the condition is satisfied, performing each action for the rule based on the one or more parameters for the action.

2. The method of claim 1 wherein the evaluating is performed by an XPath expression, wherein the expression prompts a review of the unstructured document for the presence of at least one fact and returns a value based on the evaluation of the at least one fact.

3. The method of claim 1 wherein a rule comprises an XSLT template.

4. The method claim 1, further comprising prioritizing a plurality of rules in the rule set, wherein the rule used in the evaluating is based on the prioritization.

5. The method of claim 5, wherein the evaluating and performing an action are performed for a plurality of rules in the rule set in an order determined by at least the prioritization.

6. A rule engine, comprising:
a rule set containing one or more rules, wherein each rule comprises a condition;
a rule evaluator that applies a rule from the rule set by receiving one or more facts from an unstructured document and determines whether the condition for the applied rule is satisfied based on the one or more facts; and an action executor that performs one or more actions for the rule if the rule evaluator determines that the condition for the applied rule is satisfied.

7. The rule engine of claim 6, wherein the action executor determines the action from the applied rule.

8. The rule engine of claim 6 wherein the condition for a rule comprises an expression to evaluate the unstructured document for the presence of at least one fact and return a value based on the evaluation of the at least one fact.

9. The rule engine of claim 6, where the rules in the rule set are represented in XML and the rule evaluator comprises an XPath processor.

10. The rule engine of claim 6, where the rules in the rule set are represented in XML and the rule evaluator comprises an XSLT template.

11. The rule engine of claim 10, further comprising:
a preprocessor, wherein the preprocessor accepts one or more preprocessing instructions, wherein the preprocessing instructions describe one or more operations for receiving global parameters.

12. The rule engine of claim 7, further comprising an action library for storing one or more actions, wherein the act-Lon executor calls instructions for implementing the action from the action library.

13. The rule engine of claim 6 wherein each rule further comprises a priority.

14. The rule engine of claim 13 wherein the rule evaluator evaluates the rules in an order determined by at least the priority for each rule.

15. A method for applying one or more rules to a document file, the method comprising:
accessing a rule set containing one or more rules, wherein each rule comprises a condition, wherein the rules include one or more action parameters;
receiving one or more facts from an unstructured document; and
for at least one rule in the rule set:
evaluating whether the condition for the rule is satisfied based on the one or more facts, and
if the condition is satisfied, accessing an action library to identify an action to be performed based on the action parameters, and
performing the identified action.

16. The method of claim 15 wherein the evaluating is performed by an XPath expression, wherein the expression prompts a review of the unstructured document based on at least one fact and returns a value based on the evaluation of the at least one fact.

17. The method of claim 15 wherein a rule comprises an XSLT template.

18. The method of claim 15 wherein each rule further comprises a priority.

19. The method of claim 19 wherein the one or more rules in a rule set are evaluated in an order determined by at least the priority for each rule.

20. The method of claim 17, further comprising:
accepting one or more preprocessing instructions, wherein the preprocessing instructions describe one or more operations for receiving global parameters.
